(19) United States
(12) Patent Application Publication
(10) Pub. No.: US 2020/0091616 A1
(43) Pub. Date: Mar. 19, 2020

(54) METHOD FOR PRODUCING A DIRECTION-FINDING ANTENNA ARRAY AND ANTENNA ARRAY PRODUCED ACCORDING TO SUCH A METHOD

(71) Applicant: THALES, COURBEVOIE (FR)

(72) Inventors: Luc BOSSER, Elancourt (FR); Serge GUELGUELIAN, Elancourt (FR); Renaud SAADA, Elancourt (FR); Antoine DUMARQUEZ, Elancourt (FR)

(21) Appl. No.: 16/467,972

(22) PCT Filed: Dec. 8, 2017
(86) PCT No.: PCT/EP2017/081957

§ 371 Date: Jun. 9, 2019

(30) Foreign Application Priority Data
Dec. 15, 2016 (FR) 1601783

(51) Int. Cl. H01Q 21/00; G01S 3/04; H01Q 21/22

(52) U.S. Cl. CPC H01Q 21/0087; H01Q 21/22; G01S 3/043

(57) ABSTRACT

A method for manufacturing a radio-direction-finding antenna array in two dimensions includes a step of designing the antenna array with the help of predetermined constraints, the designing step comprising: a step of defining a reference antenna network, a step of searching for configurations to be taken into consideration of each of the antennas forming a direction-finding antenna array, a step of quantifying the maximum level of ambiguities of each of the possible configurations with the help of a correlation function so as to associate an evaluation quantity with each of the configurations considered, a step of searching for and selecting the configuration exhibiting the lowest evaluation quantity.

The subject of the present invention is a method for producing a direction-finding antenna array and an antenna array produced according to such a method. The invention applies notably in the field of the detection of radioelectric signals in electronic warfare (Electronic Support), these signals possibly originating from radars, from telecommunication transmitters or from any other device radiating such a signal.

The invention relates more particularly to radio-direction-finding and more precisely to a method for manufacturing a direction-finding antenna array able to measure the direction of arrival of a radioelectric signal. The invention also relates to a direction-finding antenna array produced according to such a method.

In general, electronic warfare applications are concerned with very brief signals, this being particularly true for radar signals. This leads to embodiments of direction finders based necessarily on an array of several fixed antennas which, illuminated by the relevant radioelectric signal, will deliver a set of signals that are input at the same time, this set being a carrier of the Direction Of Arrival (or DOA) of said signal. Several estimators exist for calculating the direction of arrival. Before calculating, a need is to acquire this set of signals, this involving as many reception chains as antennas. The reception chains being relatively expensive hardware entities, it is therefore important to optimize their number, that is to say to design direction-finding antenna arrays for which one seeks either to maximize the performance for a given number of antennas, or to minimize the number of antennas for given performance.

The design of a direction-finding antenna array must generally comply with a specification that fixes the requirements, the latter being able to be expressed according to three categories:
A first category relates to the characteristics of the antennas used to construct the direction-finding antenna array. For each antenna, one has at one's disposal its gain (amplitude and phase) as a function of the direction of arrival, the frequency and the incident radioelectric signal polarization.
A second category relates to the geometric constraints, on the carrier platform, of placement of the direction-finding antenna array, including the relative positions of the antennas. These constraints describe at least the surface area covered by each antenna and the maximum surface area allowed for housing the direction-finding antenna array. In fact, there exists a minimum spacing between antennas.
A third category describes the performance to be achieved by the user device of the direction-finding antenna array. Included among the latter are the spatial coverage, frequency coverage and coverage in terms of polarization, the precision and the rate of direction-finding ambiguities.

Hereinafter, one will speak of direction-finding ambiguity. This problem exists when the direction-finding antenna array exhibits two responses which are similar or very greatly alike, for two sufficiently different directions of arrival. This is due in principle to the fact that a phase shift is measured only to within an integer number of times 2π. Thus when two antennas are not less than half a wavelength of an incident signal apart, the geometric phase shift between phase centers of the antennas, that could exceed 2π, will be measured with ambiguity and the direction of arrival that the direction finder will provide will be ambiguous.

This problem is well known in interferometers. A solution then consists in using an irregular arrangement of the antennas to vary the angular spacing of the ambiguities from one pair of antennas to another. A judicious arrangement of the antennas thus ultimately makes it possible to utilize the redundancy of the information measured by the various pairs of antennas to determine the direction of arrival without ambiguity.

This well-known interferometry technique utilizes solely the phase shifts between antennas without taking account of the amplitude. Insofar as the amplitude would make sense on account of the definition of the constituent antennas, it would be judicious to use this amplitude to improve the measurements of direction of arrival.

Moreover, the interferometric direction-finding antenna arrays, or interferometry bases, are very generally antennas aligned in the desired angular measurement plane. If the direction of arrival of the incident radioelectric signal lies in an inclined plane with respect to this measurement plane, then the measurement may be very erroneous. This is why a bearing-wise interferometer must be compensated elevation-wise should it have to work in a sufficiently significant range of elevations in regard to its bearing-wise precision; it is then necessary to add, for example, to a bearing-wise interferometer, an elevation-wise direction finder which may also be an interferometer. In such a case, all the antennas do not participate directly in the estimation of the two angles but indirectly by correction. This type of solution is therefore poorly suited for dimensioning a direction-finding antenna array in which all the antennas are exploited directly so as to jointly estimate the two angles. Moreover, this technique is equally inappropriate for devising a direction-finding antenna array in which the antennas exhibit different matched polarizations, since the phase difference between two antennas is then no longer related solely to the direction of arrival, but also depends on the polarization of the incident radioelectric signal.

An aim of the invention is notably to correct all or some of the drawbacks of the prior art by proposing a solution making it possible to estimate the direction of arrival of an incident signal in two dimensions.

To this effect, the subject of the invention is a method for manufacturing a direction-finding antenna array in two dimensions comprising at least three antennas, comprising a phase of determining the optimal configuration of said array from among a list of possible configurations, a configuration being defined by the gain, the direction of pointing and the position within said array of each of said antennas, said phase comprises at least:
A step of defining a reference antenna network, said network covering a surface having a dimension in elevation and/or in bearing inversely proportional respectively to a level of precision required in elevation and/or in bearing for the estimation of the directions of arrival of the incident waves, and comprising a plurality of elementary antennas, said elementary antennas being distributed according to a regular mesh, the distance separating two contiguous elementary antennas being substantially equal to the half-wavelength associated with the maximum frequency of a span of frequencies of interest, the number of antennas of said reference antenna network being greater than the number of antennas of said array, the spacing between the extreme antennas of said network being greater than or equal to the spacing between the extreme antennas of said array along the bearing axis and/or the elevation axis,
A step of searching for configurations to be taken into consideration with the help of predetermined constraints so as to establish a list of configurations to be taken into consideration,
A step of quantifying the maximum level of ambiguities of each of the configurations of said list with the help of a correlation function so as to associate an evaluation quantity with each of said configurations,
A step of searching for the configuration exhibiting the lowest evaluation quantity, said configuration being the optimal configuration.

In a particular mode of implementation, said direction-finding antenna array being intended for measurements of direction of arrival of incident radioelectric signals not depending on the polarization of these said signals, the evaluation quantity associated with a configuration is equal to the maximum value of a correlation function F_{Cor}(Θ₁, Θ₂) dependent on two directions of arrival where Θ₁ and Θ₂ representing two directions of arrival scanning the domain of coverage of direction of arrival of said configuration for the one and the domain of direction of arrival of interest for the other, and by excluding the values for which the correlation function of said reference antenna network F_{CorRef}(Θ₁, Θ₂) is greater than or equal to a predetermined threshold S_{Ref}, the correlation functions F_{Cor}(Θ₁, Θ₂) and F_{CorRef}(Θ₁, Θ₂) being expressed respectively with the help of the pointing vector of said configuration and of the pointing vector of said reference array.

In another possible embodiment, said antenna array being intended for measurements of direction of arrival of incident radioelectric signals depending on the polarization of these said signals, the evaluation quantity associated with a configuration is equal to the maximum value of the eigenvalues of a matrix Γ*(Θ₁, Θ₂)·Γ(Θ₁, Θ₂), dependent on two directions of arrival where Θ₁ and Θ₂ representing two directions of arrival scanning the domain of angular coverage of said configuration for the one and the angular domain of interest for the other, where:

$$Γ ( {Θ}_{1} , {Θ}_{2} ) = [ \begin{matrix}{U}_{Hnorm}^{*} ( {Θ}_{1} , {λ}_{m i n} ) \\ {U}_{Vnorm}^{*} ( {Θ}_{1} , {λ}_{m i n} )\end{matrix} ] \cdot [ \begin{matrix}{U}_{Hnorm} ( {Θ}_{2} , {λ}_{m i n} ) & {U}_{Vnorm} ( {Θ}_{2} , {λ}_{m i n} )\end{matrix} ]$$

where:
Γ(Θ₁, Θ₂) is a square 2×2 matrix;

$$[ \begin{matrix}{U}_{Hnorm}^{*} ( {Θ}_{1} , {λ}_{m i n} ) \\ {U}_{Vnorm}^{*} ( {Θ}_{1} , {λ}_{m i n} )\end{matrix} ]$$

is a 2×N matrix;
[U_{Hnorm}(Θ₂, λₘᵢₙ) U_{Vnorm}(Θ₂, λₘᵢₙ)] is an N×2 matrix;
U_{Hnorm}(Θ, λₘᵢₙ) and U_{Vnorm}(Θ, λₘᵢₙ) are two vectors forming an orthonormal basis of the plane generated by the two pointing vectors U_{H}(Θ, λₘᵢₙ) and U_{V}(Θ, λₘᵢₙ) of the direction-finding antenna array at the minimum wavelength, respectively in horizontal linear polarization and in vertical linear polarization,
The sign * corresponds to the transpose conjugate transformation.

The list of configurations to be taken into consideration corresponds for example to the complete list of possible configurations.

In another possible mode of implementation, the list of configurations to be taken into consideration corresponds for example to a random draw of a predetermined number of configurations from among the complete list of possible configurations.

The reference antenna network antennas being aligned according to a mesh, the positions in the possible configurations of the antennas of the direction-finding antenna array are for example aligned with said mesh.

Said reference antenna network is for example a network of radiating elements, each antenna of said direction-finding antenna array being produced with the help of a sub-network of said network.

The subject of the invention is also a direction-finding antenna array obtained by such a method.

Other particularities and advantages of the present invention will become more clearly apparent on reading the description hereinafter, given by way of nonlimiting illustration and with reference to the appended drawings for which:

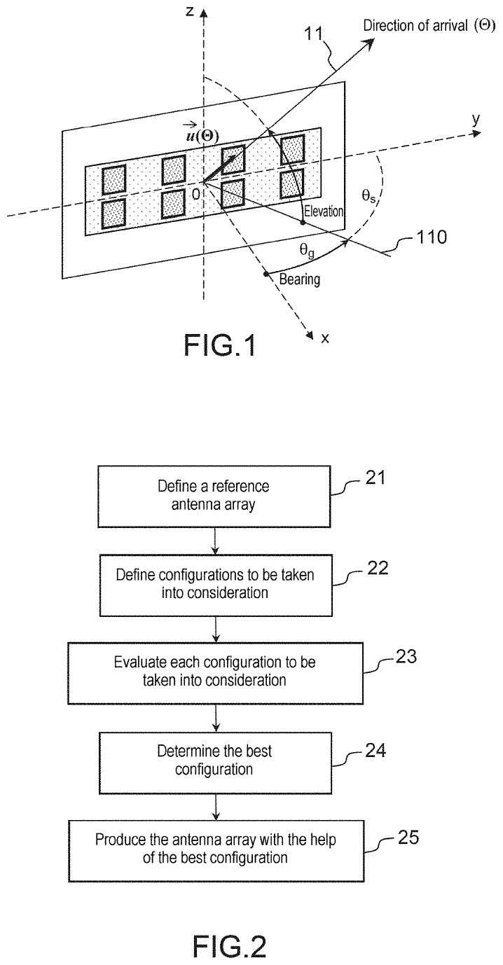

FIG. 1 illustrates a definition of the geometric reference frame used and of the particular angles of bearing and of elevation;

FIG. 2 represents possible steps of the design of a direction-finding antenna array in two dimensions;

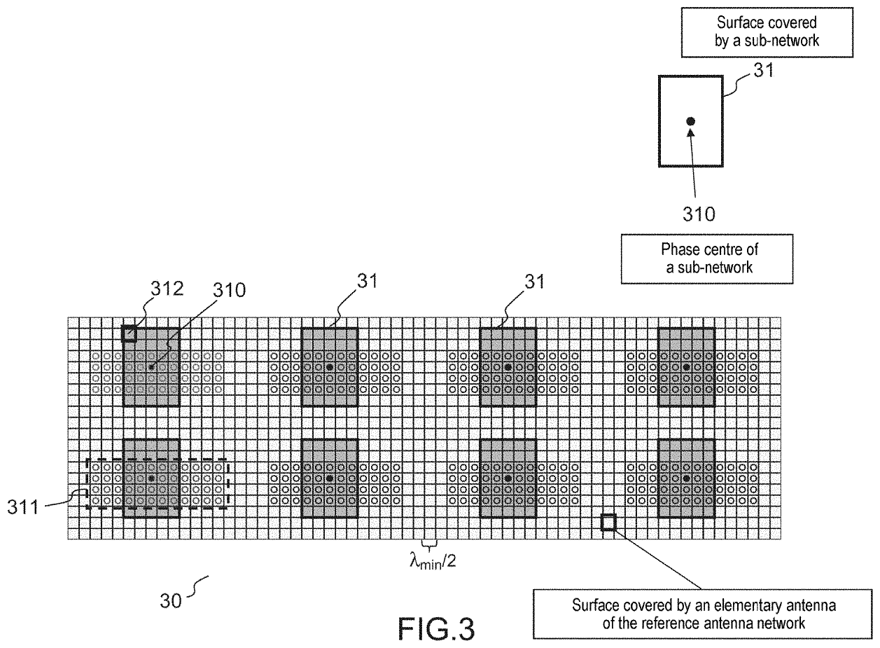

FIG. 3 represents an exemplary embodiment of a direction-finding antenna array in two dimensions in the case of polarization non-dependency;

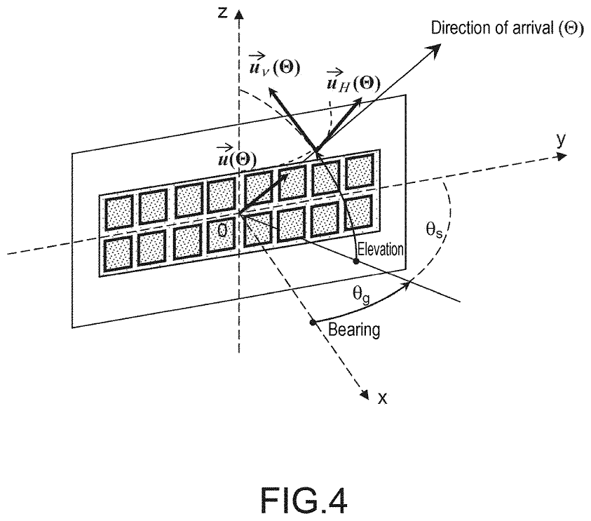

FIG. 4 represents an exemplary embodiment of a direction-finding antenna array in two dimensions in the case of polarization dependency (polarization diversity case);

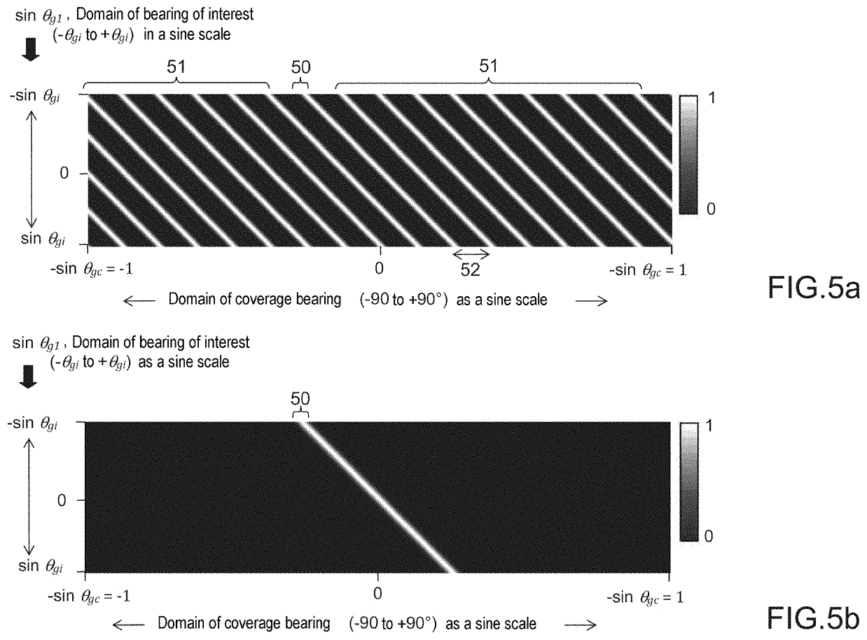

FIGS. 5a and 5b are graphical representations of the correlation functions of the direction-finding antenna array corresponding to the configuration depicted in FIG. 3 and of the reference antenna network, respectively F_{Cor}(Θ₁, Θ₂) and F_{CorRef} (Θ₁, Θ₂);

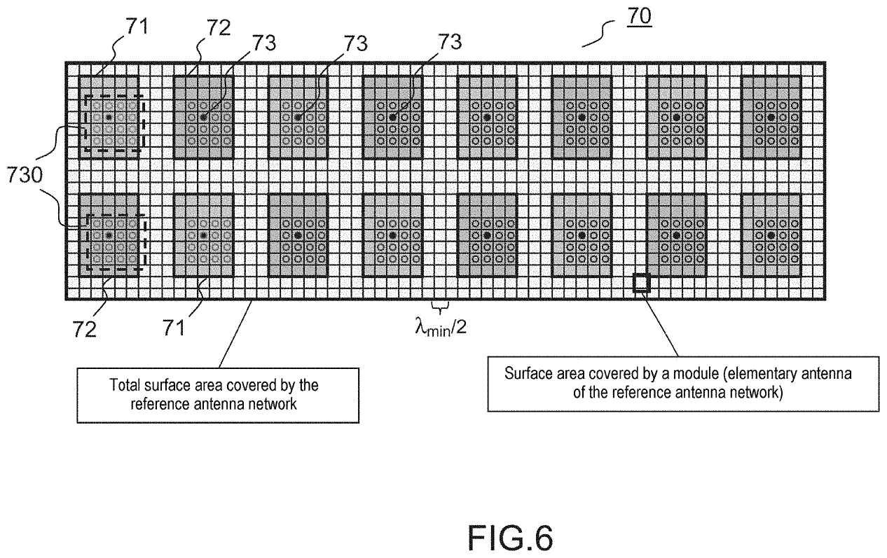

FIG. 6 illustrates a definition of the geometric reference frame used with a direction-finding antenna array with polarization diversity;

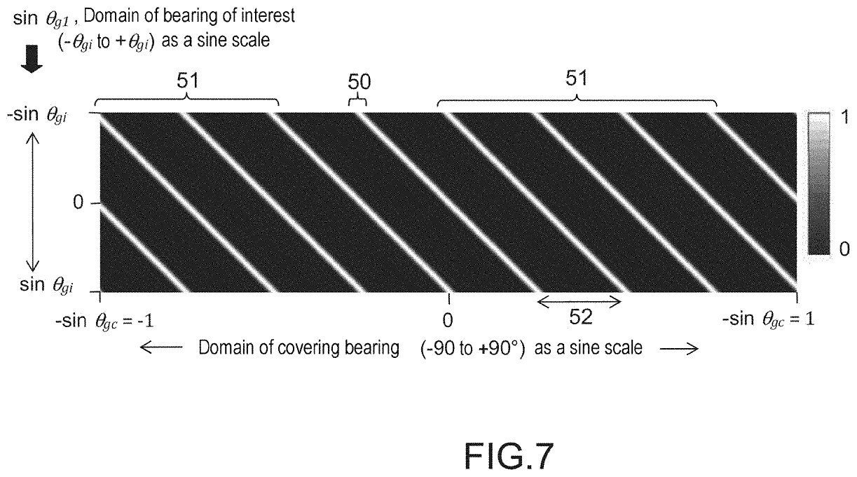

FIG. 7 is a graphical representation of the generalized correlation (matrix calculation) of the direction-finding antenna array with polarization diversity depicted in FIG. 6;

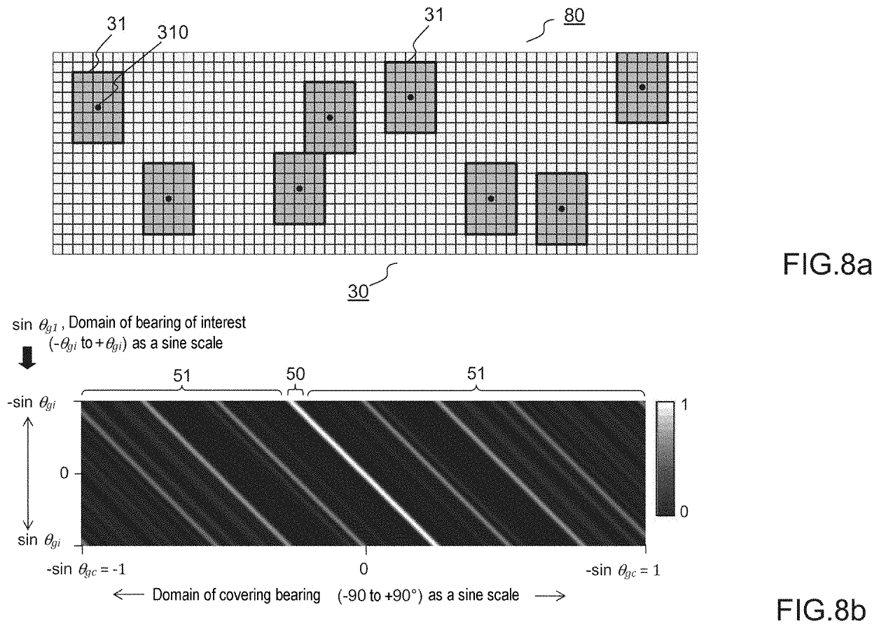

FIGS. 8a and 8b represent respectively a configuration of a direction-finding antenna array which is designed according to the invention and the graphic of the correlation function illustrating the results obtained for this configuration;

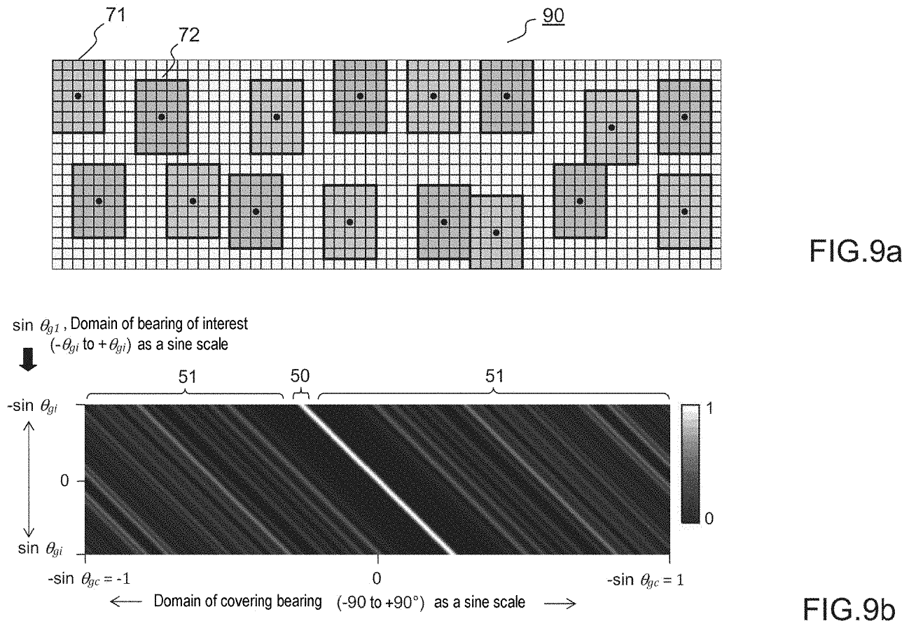

FIGS. 9a and 9b represent respectively a configuration of a direction-finding antenna array with polarization diversity which is designed according to the invention and the graphic of the generalized correlation illustrating the results obtained for this configuration.

The subject of the present invention is a method for producing a direction-finding antenna array able to work according to two angular dimensions, for example bearing and elevation. If required, the method is obviously applicable with a single angular dimension.

FIG. 1 recalls that, for any direction of arrival, depicted by a direction-of-arrival straight line 11, the bearing is the angle formed by the straight line 110, corresponding to the projection of the direction-of-arrival straight line on the horizontal plane, and a reference axis in this horizontal plane (or lubber line, for example the normal to a plane of alignment of the antennas). The elevation is the angle formed by the direction-of-arrival straight line 11 and its projection 110 on the horizontal plane.

Hereinafter, the term direction of arrival will be used, symbolized by Θ, and therefore generally defined by two angles, the bearing Θ_{g} and the elevation θₛ, Θ=(θ_{g}, θₛ).

The direction-finding antenna array can be produced equally well with the help of non-network conventional antennas (spiral, sinuous, butterfly, horn, etc.) as with the help of a network antenna in which an array of sub-networks is defined, this array forming said direction-finding antenna array. Stated otherwise, the array is then produced with the help of beams formed with sub-networks of a network of elementary antennas.

The method according to the invention comprises a phase of searching for the optimal configuration of the direction-finding antenna array, followed by a phase of production with the help of this optimal configuration.

In general, by configuration is meant the definition of each constituent antenna within the array, that is to say the gain dependent on direction of arrival, on frequency and on polarization, the position of the phase center and the direction of pointing, irrespective of the embodiment with conventional antennas or with formed beams. This exhaustive definition of a configuration can, however, be simplified as will be seen further on.

The method according to the invention comprises for example the following steps presented in FIG. 2:
A first step 21 of defining a reference antenna network;
A second step 22 of defining the configurations to be taken into consideration;
A third step 23 of evaluating each configuration to be taken into consideration, by a scheme involving the reference antenna network and making it possible to assess the direction-finding quality in terms of ambiguities and precision;
A fourth step 24 of determining the best configuration;
A fifth step 25 of producing the direction-finding antenna array corresponding to this best configuration.

The first step of defining a reference antenna network consists in defining a plurality of K elementary antennas, all identical, whose phase centers are arranged regularly on a meshed surface. The distance between two contiguous antennas of the network must substantially be less than half the minimum wavelength, the minimum wavelength λₘᵢₙ corresponding to the maximum working frequency fₘₐₓ, which is the maximum frequency of a span of frequencies of interest, specific to each application. The lengths of the network, in the horizontal and vertical sectional planes, are inversely proportional to the bearing-wise and elevation-wise direction-finding precisions respectively. The number of antennas of the reference antenna network is greater than the number of antennas of the antenna array. The spacing between the extreme antennas of the reference antenna network is greater than or equal to the spacing between the extreme antennas of the antenna array, irrespective of which axis is considered, elevation or bearing.

In general, this meshed surface is not necessarily plane, it may for example be cylindrical. However, a simplified variant may be a plane meshed surface.

This reference antenna network is a simple calculational stratagem in the method in the case where the direction-finding antenna array is produced with conventional antennas. On the other hand, in the case where the direction-finding antenna array is produced by beams formed with the help of sub-networks, this reference antenna network can correspond concretely to the network of elementary antennas with which the sub-networks generating said formed beams are produced.

The object of the second step of defining the configurations to be taken in consideration is to provide the third step with a configuration list to be evaluated in such a way that the fourth step can choose, from among them, the best according to a criterion regarding the quantity serving to evaluate each configuration.

It is recalled that a configuration corresponds to the physical definition of a direction-finding antenna array, this array comprising N antennas, N being an integer greater than or equal to 2. This physical definition corresponds, for each of the N constituent antennas in the most general case, to the gain dependent on direction of arrival, on frequency and on polarization, to the position of the phase center and to the direction of pointing. This is valid irrespective of the embodiment, with conventional antennas or with formed beams.

The definition of a configuration may however be simplified in a large number of possible cases. A variant embodiment may then culminate in a configuration that reduces solely to the positions of the phase centers of the antennas in a plane, these all being identical, placed in a plane and pointing in the same direction.

It should be noted that the antenna gain (dependent on direction of arrival, on frequency and on polarization) is a definition aimed at generalization. Indeed, for current cases of use, there will not be a tendency to employ constituent antennas that differ from one another, except in polarization response for polarization diversity reasons.

These configurations are tailored by the specification and by geometric and technical considerations depending on the mode of production of the direction-finding antenna array. For example, in the case of production with conventional antennas, the antennas being allowed neither to get in one another's way mechanically, nor to mask one another, it will not be possible for them to overlap. On the other hand, in the case of formed beams, it would be possible for the antennas to overlap insofar as the formations of beams by sub-network would so permit; this is a technical question of specification.

The reference antenna network, defined in the first step, provides the regular mesh of the surface of implantation of the phase centers of the K constituent antennas of this network, with a mesh cell pitch d of substantially less than half the minimum wavelength λₘᵢₙ/2. The phase centers of the constituent antennas of the direction-finding antenna array, with beamforming, being able to align themselves with a mesh cell half-pitch d/2 according to the beamforming, it will be possible to use this half-pitch mesh also when the antennas are conventional.

FIG. 3 illustrates a plane example of embodiment of a direction-finding antenna array 30 as well as the possible positions of each of the phase centers of the antennas thus produced with the sub-networks 31. So as not to overload the figure, only the possible locations 311 of the phase centers 310 of each of the antennas 31 have been represented.

According to a first mode of implementation, in the course of this step, it is possible to compile a list of all the possible configurations of the direction-finding antenna array, by establishing all the possible combinations having regard to the constraints and to the specification.

According to a second, alternative, mode of implementation, the list of configurations to be evaluated can be established by selecting in a random manner, in the array of possible configurations, a restricted number of configurations relative to the possible totality. The aim of this mode is to avoid too large a number of configurations to be evaluated as third step, if the application is constrained in execution time. Insofar as the configurations are limited to the positions of the phase centers of the antennas, it is interesting to note that random drawing will reproduce the statistic in respect of irregularity of the configurations, implying that it will be possible to have, in the list thus restricted, a configuration which is sufficiently irregular to have a sufficiently low level of direction-finding ambiguities.

The third step is based on an evaluation of the maximum level of direction-finding ambiguities produced by each configuration of direction-finding antenna array, each evaluated configuration having been defined in the second step.

A direction-finding ambiguity corresponds to identical measurements of direction of arrival for different actual directions of arrival. In practice, having regard to imperfections of hardware production and measurement noise of any kind, a direction-finding ambiguity corresponds to measurements of direction of arrival that are close for sufficiently distant actual directions of arrival.

The level of direction-finding ambiguities can be evaluated by correlating the measurements of directions of arrival that are performed by a direction-finding antenna array in a given domain of directions of arrival, by eliminating from this domain the cases for which the correlation of the measurements of direction of arrival is normal, this being seen through the correlation of the measurements of direction of arrival of the reference antenna network which produces an ideal response.

The correlation can be supported by a calculation of correlation function which is more or less generalized depending on whether the measurements of direction of arrival do or do not depend on the polarization of the radioelectric signals having to be processed.

To perform this calculation, two domains of directions of arrival need to be distinguished: the domain of coverage and the domain of interest. The domain of coverage is the domain of directions of arrival for which the direction-finding antenna array may receive radioelectric signals. The domain of interest is given by the specification, it is at most equal to the domain of coverage, it is generally restricted relative to the latter.

In a practical manner to calculate the more or less generalized correlation functions, it will be possible to take angular values that are not linearly distributed in these domains, but angular values whose sines are linearly distributed. This makes it possible advantageously to reduce the number of directions of arrival while taking into account, if need be, the squint-related broadening of the formed beams.

The first case is that where the direction-of-arrival measurements performed with the direction-finding antenna array do not depend on the polarization of the incident radioelectric signals. In this case, the correlation is expressed by a simple correlation function. The maximum level of ambiguities of a direction-finding antenna array, associated with a given configuration, corresponds to the maximum value of the correlation function of said array

$${max}_{{Θ}_{1} , {Θ}_{2}} ( {F}_{Cor} ( {Θ}_{1} , {Θ}_{2} ) )$$

where Θ₁ and Θ₂ are two directions of arrival scanning the domain of coverage for the one and the domain of interest for the other (the assignment of the domains to Θ₁ and to Θ₂ is immaterial), and by excluding the values for which the correlation function of the reference antenna network F_{CorRef}(Θ₁, Θ₂) is greater than or equal to a predetermined threshold S_{Ref}. In general, the result lies between 0 and 1, bound included. A preferential value of the threshold S_{Ref} is 0.5.

The correlation functions F_{Cor}(Θ₁, Θ₂) and F_{CorRef}(Θ₁, Θ₂) are expressed respectively with the help of the pointing vector (or steering vector) of the direction-finding antenna array U(Θ, λₘᵢₙ) and of the pointing vector of the reference antenna network U_{Ref}(Θ, λₘᵢₙ):

F_{cor}(Θ₁, Θ₂)=|U*(Θ₁, λₘᵢₙ)·U(Θ₂, λₘᵢₙ)|² and F_{CorRef}(Θ₁, Θ₂)=|U*_{Ref}(Θ₁, λₘᵢₙ)·U_{Ref}(Θ₂, λₘᵢₙ)|²

where the sign * corresponds to the transpose conjugate transformation.

In general, a pointing vector of a group G of P antennas, U_{G}(Θ, λ), is a unit vector comprising P components, whose p-th component is proportional to the response of the p-th antenna, in amplitude and phase,

$${A}_{G , p} ( Θ , λ ) = {D}_{G , p} ( Θ , λ ) \cdot {e}^{j \frac{2 π}{λ} \cdot {\vec{OM}}_{G , p} \cdot \vec{u} ( Θ )}$$

where, as illustrated by FIG. 1:
D_{G,p}(Θ, λ) is the radiation pattern or gain (amplitude and phase) of the p-th antenna of the group G in the direction of arrival Θ and at the wavelength λ;
M_{G,p} is the position in space of the phase center of the p-th antenna of the group G with respect to an origin O;
\vec{u}(Θ) is the unit vector carried by the direction of arrival Θ;

$${e}^{j \frac{2 π}{λ} \cdot {\vec{OM}}_{G , p} \cdot \vec{u} ( Θ )}$$

represents the phase shift term related to the position of the phase center of the p-th antenna in the group G.

In general, the pointing vector U_{G}(Θ, λ) can be expressed as the ratio of the vector A_{G}(Θ, λ), whose p-th component is A_{G,p}(Θ, λ), to its Euclidean norm ∥A_{G}(Θ, λ)∥ which can itself be expressed in the following manner ∥A_{G}(Θ, λ)∥=\sqrt{A*_{G}(Θ, λ)·A_{G}(Θ, λ)}, A*_{G}(Θ, λ) is the conjugate transpose vector of the vector A_{G}(Θ, λ).

The pointing vector U(Θ, λₘᵢₙ) is obtained by application of the foregoing to the N antennas of the direction-finding antenna array.

The pointing vector U_{Ref}(Θ, λₘᵢₙ) is obtained by application of the foregoing to the K antennas of the reference antenna network. Having regard generally to the weak directivity of the antennas of the reference antenna network, in an implementation variant, the gains D_{Ref,k}(Θ, λ) can be replaced by 1. In another implementation variant, these gains D_{Ref,k}(Θ, λ) can be replaced by weighting coefficients Pₖ which differ from antenna to antenna, with the aim of not penalizing a configuration of the direction-finding antenna array offering a lower level of ambiguities at the cost of a slight degradation in the precision of direction of arrival.

The second case is that where the direction-of-arrival measurements performed with the direction-finding antenna array depend on the polarization of the radioelectric signals, both for reasons of diversity of polarization of the incident radioelectric signals and for reasons of polarization response of the constituent antennas. When the direction-finding antenna array must be able to deal with diversity of polarization of incident signals, it is necessary to use constituent antennas that can form a basis of decomposition of the polarization, which is preferably orthogonal. For example, antennas with horizontal linear matched polarization and antennas with vertical linear matched polarization are used conventionally. But this can also be antennas with right circular matched polarization and antennas with left circular matched polarization.

In this case, the correlation at the level of the direction-finding antenna array rises with the matrix product Γ*(Θ₁, Θ₂)·Γ(Θ₁, Θ₂) and the maximum level of ambiguities corresponds to the largest eigenvalue of this matrix product:

VPₘₐₓ[Γ*(Θ₁, Θ₂)·Γ(Θ₁, Θ₂)]

with

$$Γ ( {Θ}_{1} , {Θ}_{2} ) = [ \begin{matrix}{U}_{Hnorm}^{*} ( {Θ}_{1} , {λ}_{m i n} ) \\ {U}_{Vnorm}^{*} ( {Θ}_{1} , {λ}_{m i n} )\end{matrix} ] \cdot [ \begin{matrix}{U}_{Hnorm} ( {Θ}_{2} , {λ}_{m i n} ) & {U}_{Vnorm} ( {Θ}_{2} , {λ}_{m i n} )\end{matrix} ]$$

where:
VPₘₐₓ signifies maximum eigenvalue;
Γ(Θ₁, Θ₂) is a 2×2 square mix;

$$[ \begin{matrix}{U}_{Hnorm}^{*} ( {Θ}_{1} , {λ}_{m i n} ) \\ {U}_{Vnorm}^{*} ( {Θ}_{1} , {λ}_{m i n} )\end{matrix} ]$$

is a 2×N matrix;
[U_{Hnorm}(Θ₂, λₘᵢₙ) U_{Vnorm}(Θ₂, λₘᵢₙ)] is an N×2 matrix;
U_{Hnorm}(Θ, λₘᵢₙ) and U_{Vnorm}(Θ, λₘᵢₙ) are two vectors forming an orthonormal basis of the plane generated by the two pointing vectors U_{H}(Θ, λₘᵢₙ) and U_{V}(Θ, λₘᵢₙ) of the direction-finding antenna array at the minimum wavelength, respectively in horizontal linear polarization (H) (corresponding to an electric field collinear with the vector \vec{u}_{H}(Θ) of FIG. 4, said vector being a unit vector orthogonal to the direction-of-arrival straight line defined by Θ and situated in the local horizontal plane of the direction-finding antenna array) and in vertical linear polarization (V) (corresponding to an electric field collinear with the vector uᵥ(0) of FIG. 4, said vector being a unit vector orthogonal to the direction-of-arrival straight line defined by Θ and situated in the local vertical plane, comprising the direction-of-arrival straight line, of the direction-finding antenna array), that can take for example the following form:

$${U}_{Hnorm} ( Θ , {λ}_{m i n} ) = {U}_{H} ( Θ , {λ}_{m i n} ) and$$

$${U}_{Vnorm} ( Θ , {λ}_{m i n} ) = \frac{{U}_{V} ( Θ , {λ}_{m i n} ) - ( {U}_{H}^{*} ( Θ , {λ}_{m i n} ) \cdot {U}_{V} ( Θ , {λ}_{m i n} ) ) \cdot {U}_{H} ( Θ , {λ}_{m i n} )}{‖ {U}_{V} ( Θ , {λ}_{m i n} ) - ( {U}_{H}^{*} ( Θ , {λ}_{m i n} ) \cdot {U}_{V} ( Θ , {λ}_{m i n} ) ) \cdot {U}_{H} ( Θ , {λ}_{m i n} ) ‖}$$

The sign * corresponds to the transpose conjugate transformation.

The pointing vectors U_{H}(Θ, λₘᵢₙ) and U_{V}(Θ, λₘᵢₙ) are unit vector comprising N components since they correspond to the direction-finding antenna array which possesses N antennas, their n-th components are proportional to the responses, in amplitude and phase, of the n-th antennas respectively in horizontal polarization

$${A}_{H , n} ( Θ , λ ) = {D}_{H , n} ( Θ , λ ) \cdot {e}^{j \frac{2 π}{λ} \cdot {\vec{OM}}_{n} \cdot \vec{u} ( Θ )}$$

and in vertical polarization

$${A}_{V , n} ( Θ , λ ) = {D}_{V , n} ( Θ , λ ) \cdot {e}^{j \frac{2 π}{λ} \cdot {\vec{OM}}_{n} \cdot \vec{u} ( Θ )} ,$$

where in a similar manner to the first case and as illustrated by FIG. 4:
D_{H,n}(Θ, λ) and D_{V,n}(Θ, λ) are the radiation patterns or gains (amplitude and phase) of the n-th antenna of the direction-finding antenna array in the direction of arrival Θ, at the wavelength λ and respectively in horizontal linear polarization and in vertical linear polarization;
Mₙ is the position in space of the phase center of the n-th antenna of the direction-finding antenna array with respect to an origin O;
\vec{u}(Θ) is the unit vector carried by the direction of arrival Θ;

$${e}^{j \frac{2 π}{λ} \cdot {\vec{OM}}_{n} \cdot \vec{u} ( Θ )}$$

represents tne phase shift term related to the position of the phase center of the n-th antenna in the direction-finding antenna array.

The fourth step of determining the best configuration consists in adopting the configuration of the direction-finding antenna array exhibiting the lowest maximum level of ambiguities from among those calculated in the third step, and less than a predetermined threshold Sₘₐₓ. This threshold makes it possible to ensure that the maximum level of ambiguities is sufficiently low for the quality of the direction-finding and, if need be if it is not, to recommence the method according to the invention from the first step while necessarily relaxing certain constraints such as, for example, the number of direction-finding antennas N, that is to say by increasing it.

The preferential values of the threshold Sₘₐₓ are less than or equal to 0.9.

Complementary explanations are provided hereinafter, backed up with nonlimiting examples illustrated by figures.

FIGS. 5a and 5b illustrate the phenomenon of direction-finding ambiguities through the graphical representation of the correlation function. To facilitate interpretation, the direction of arrival Θ is restricted to the bearing θ_{g}, the elevation θₛ is assumed zero. As advocated previously, the bearing scales are also in terms of sine of the bearing. The domain of coverage in bearing goes from −90 to +90 degrees, and the domain of bearing interest goes from −θ_{gi}=−15 degrees to θ_{gi}=15 degrees.

FIG. 5a corresponds to the correlation function F_{Cor}(Θ₁, Θ₂)=F_{Cor}(θ_{g1}, θ_{g2}) of the configuration of the array, described previously by FIG. 3, of direction-finding antennas. In this configuration, the N direction-finding antennas exhibit the same radiation pattern pointing in the same direction and are regularly spaced according to a pitch ΔL along the y axis (horizontal), and consequently constitute an antenna array which is naturally ambiguous for the minimum wavelength λₘᵢₙ. This is manifested by a multitude of straight lines 51 in addition to the straight line 50 which is not itself to be considered to be a site of ambiguities. Indeed, FIG. 5b corresponds to the correlation function F_{CorRef}(Θ₁, Θ₂)=F_{CorRef}(θ_{g1}, θ_{g2}) of the reference antenna network, it illustrates its robustness to ambiguities, that is to say the best possible result in terms of rejection of ambiguities. Only the pairs (θ_{g1}, θ_{g2}) belonging to the straight line 50 passing through the origin, θ_{g1}=θ_{g2}, provide a value of F_{CorRef}(θ_{g1}, θ_{g2}) equal to 1, this being absolutely normal.

It will be noted that, in these graphical representations of the correlation functions, the thickness of the straight lines 50, 51 reflects the precision achievable in the estimation of direction of arrival. The finer the straight line 50, 51, the more precise the estimation of the bearing. Indeed, the thickness of these straight lines conveys the rate at which the pointing vectors become decorrelated as the directions of arrival are parted. The precision of direction of arrival ensues directly from this decorrelation rate, itself related to the geometric dimensions of the direction-finding antenna array.

It will also be noted in FIG. 5a that the spacing 52 between straight lines 50, 51 is regular and equals precisely

$$\frac{{λ}_{m i n}}{Δ L} .$$

This is to do with the fact that two bearings θ_{g1} and θ_{g2} exhibit similar pointing vectors when the difference of their sine equals an integer number of times

$$\frac{{λ}_{m i n}}{Δ L} .$$

This similarity, for this non-zero integer number, generates the ambiguities which are normal here in view of the geometry of the configuration and are manifested by the largest value of the correlation function, that is to say 1.

FIG. 6 presents an exemplary embodiment of a direction-finding antenna array 70 with polarization diversity and the possible positions of these antennas 71, 72. Just as for FIG. 3, so as not to overload the figure, only the possible locations 730 of the phase centers 73 of each of the direction-finding antennas 71, 72 have been represented. The depicted configuration is directly inspired by the depicted configuration of the array of single-polarization antennas of FIG. 3 and each antenna 71, 72 is aligned according to a regular mesh. In this example, the direction-finding antenna array with polarization diversity 70 comprises twice as many antennas distributed over one and the same surface to achieve the same precision of direction of arrival as in the configuration depicted in FIG. 3. Half of the antennas 71 possess a horizontal linear matched polarization and the other half of the antennas 72 possess a vertical linear matched polarization.

In general, the antennas 71 have matched polarization orthogonal to that of the antennas 72, and these antennas 71, 72 can be arranged in any way to form the direction-finding antenna array on condition that as many antennas 71 as antennas 72 are used.

According to a particular embodiment, the antennas forming the direction-finding antenna array can be arranged checkerboard-fashion by alternating an antenna 71 and an antenna 72. Advantageously, this checkerboard-fashion dual-polarization architecture makes it possible:
To homogenize the probability of interception of the incident signals on the direction-finding antenna array as a function of their polarization;
To allow joint estimation of the direction of arrival and of the polarization of the intercepted signal;
To optimize the precision of direction of arrival in terms of elevation and bearing.

According to another embodiment, the direction-finding antenna array 70 with polarization diversity consists of double, so-called dual-polarization, antennas comprising two antennas of orthogonal matched polarizations whose phase centers coincide to within imperfections. In this case, the number of dual-polarization antennas is identical to that of a single-polarization antenna array 30.

FIG. 7 corresponds to the correlation function F_{Cor}(Θ₁, Θ₂)=F_{Cor}(θ_{g1}, θ_{g2}) for the configuration depicted in FIG. 6. The regular arrangement of the antennas 71, 72 causes ambiguities of maximum level. For domains of coverage bearing and of interest which are identical to FIG. 5a, FIG. 7 exhibits half as many straight lines, this being normal since the spacing along the y axis (horizontal) between two successive antennas is decreased in a ratio of two.

FIG. 8a gives an exemplary configuration of a direction-finding antenna array 80 which is designed according to the invention. This configuration has been adopted from among a list of ten thousand possible configurations, obtained through a succession of random draws. For a domain of direction of arrival of interest comprising bearings between −15 and +15 degrees and elevations between −10 and +10 degrees, the correlation function F_{Cor}(Θ₁, Θ₂) is less than 0.75. FIG. 8b graphically represents the correlation function F_{Cor}(Θ₁, Θ₂)=F_{Cor}(θ_{g1}, θ_{g2}) at zero elevation for bearings of interest between −15 and +15 degrees and coverage bearings between −90 and +90 degrees, the value of this function exhibits a value of less than 0.7 away from the straight line 50. Comparison of FIGS. 5a and 8b makes it possible to demonstrate the appreciable reduction in the level of the ambiguities of the direction-finding antenna array, the precision of direction of arrival being unchanged.

FIG. 9a gives an exemplary configuration of a direction-finding antenna array 90 with polarization diversity which is designed according to the invention. This configuration has been adopted from among a list of a million possible configurations, obtained through a succession of random draws. For a domain of direction of arrival of interest comprising bearings between −15 and +15 degrees and elevations between −10 and +10 degrees, the correlation function F_{Cor}(Θ₁, Θ₂) is less than 0.85. FIG. 9b graphically represents the correlation function F_{Cor}(Θ₁, Θ₂)=F_{Cor}(θ_{g1}, θ_{g2}) at zero elevation for bearings of interest between 15 and +15 degrees and coverage bearings between −90 and +90 degrees, the value of this function exhibits a value of less than 0.5 away from the straight line 50. Comparison of FIGS. 7 and 9b makes it possible to demonstrate the appreciable reduction in the level of the ambiguities of the direction-finding antenna array, the precision of direction of arrival being unchanged.

1. A method for manufacturing a direction-finding antenna array in two dimensions comprising at least three antennas, wherein comprising a phase of determining the optimal configuration of said array from among a list of possible configurations, a configuration being defined by the gain, the direction of pointing and the position within said array of each of said antennas, said phase comprises at least:
a step of defining a reference antenna network, said network covering a surface having a dimension in elevation and/or in bearing inversely proportional respectively to a level of precision required in elevation and/or in bearing for the estimation of the directions of arrival of the incident waves, and comprising a plurality of elementary antennas, said elementary antennas being distributed according to a regular mesh, the distance separating two contiguous elementary antennas being substantially equal to the half-wavelength associated with the maximum frequency of a span of frequencies of interest, the number of antennas of said network being greater than the number of antennas of said array, the spacing between the extreme antennas of said network being greater than or equal to the spacing between the extreme antennas of said array along the bearing axis and/or the elevation axis,
a step of searching for configurations to be taken into consideration with the help of predetermined constraints so as to establish a list of configurations to be taken into consideration,
a step of quantifying the maximum level of ambiguities of each of the configurations of said list with the help of a correlation function so as to associate an evaluation quantity with each of said configurations,
a step of searching for the configuration exhibiting the lowest evaluation quantity, said configuration being the optimal configuration.

2. The method as claimed in claim 1, wherein said direction-finding antenna array being intended for measurements of direction of arrival of incident radioelectric signals not depending on the polarization of these said signals, the evaluation quantity associated with a configuration is equal to the maximum value of a correlation function F_{Cor}(Θ₁, Θ₂) dependent on two directions of arrival where Θ₁ and Θ₂ representing two directions of arrival scanning the domain of coverage of direction of arrival of said configuration for the one and the domain of direction of arrival of interest for the other, and by excluding the values for which the correlation function of said reference antenna network F_{CorRef}(Θ₁, Θ₂) is greater than or equal to a predetermined threshold S_{Ref}, the correlation functions F_{Cor}(Θ₁, Θ₂) and F_{CorRef}(Θ₁, Θ₂) being expressed respectively with the help of the pointing vector of said configuration and of the pointing vector of said reference array.

3. The method as claimed in claim 1, wherein said antenna array being intended for measurements of direction of arrival of incident radioelectric signals depending on the polarization of these said signals, the evaluation quantity associated with a configuration is equal to the maximum value of the eigenvalues of a matrix Γ*(Θ₁, Θ₂)·Γ(Θ₁, Θ₂), dependent on two directions of arrival where Θ₁ and Θ₂ representing two directions of arrival scanning the domain of angular coverage of said configuration for the one and the angular domain of interest for the other, where:
$$Γ ( {Θ}_{1} , {Θ}_{2} ) = [ \begin{matrix}{U}_{Hnorm}^{*} ( {Θ}_{1} , {λ}_{m i n} ) \\ {U}_{Vnorm}^{*} ( {Θ}_{1} , {λ}_{m i n} )\end{matrix} ] \cdot [ \begin{matrix}{U}_{Hnorm} ( {Θ}_{2} , {λ}_{m i n} ) & {U}_{Vnorm} ( {Θ}_{2} , {λ}_{m i n} )\end{matrix} ]$$
where:
Γ(Θ₁, Θ₂) is a 2×2 sauare matrix;
$$[ \begin{matrix}{U}_{Hnorm}^{*} ( {Θ}_{1} , {λ}_{m i n} ) \\ {U}_{Vnorm}^{*} ( {Θ}_{1} , {λ}_{m i n} )\end{matrix} ]$$
is a 2×N matrix;
[U_{Hnorm}(Θ₂, λₘᵢₙ) U_{Vnorm}(Θ₂, λₘᵢₙ)] is an N×2 matrix;
U_{Hnorm}(Θ, λₘᵢₙ) and U_{Vnorm}(Θ, λₘᵢₙ) are two vectors forming an orthonormal basis of the plane generated by the two pointing vectors U_{H}(Θ, λₘᵢₙ) and U_{V}(Θ, λₘᵢₙ) of the direction-finding antenna array at the minimum wavelength, respectively in horizontal linear polarization and in vertical linear polarization, The sign * corresponds to the transpose conjugate transformation.

4. The method as claimed in claim 1, wherein the list of configurations to be taken into consideration corresponds to the complete list of possible configurations.

5. The method as claimed in claim 1, wherein the list of configurations to be taken into consideration corresponds to a random draw of a predetermined number of configurations from among the complete list of possible configurations.

6. The method as claimed in claim 1, wherein the reference antenna network antennas being aligned according to a mesh, the positions in the possible configurations of the antennas of the direction-finding antenna array are aligned with said mesh.

7. The method as claimed in claim 1, wherein said reference antenna network is a network of radiating elements, each antenna of said direction-finding antenna array being produced with the help of a sub-network of said network.

8. A direction-finding antenna array, wherein it is produced by the method as claimed in claim 1.
